(19) United States
(12) Patent Application Publication
(10) Pub. No.: US 2014/0359781 A1
(43) Pub. Date: Dec. 4, 2014

(54) ELECTRONIC APPARATUS AND MANAGEMENT METHOD

(71) Applicant: KABUSHIKI KAISHA TOSHIBA, Tokyo (JP)

(72) Inventor: Shogo Ikeda, Tachikawa-shi (JP)

(73) Assignee: KABUSHIKI KAISHA TOSHIBA, Tokyo (JP)

(21) Appl. No.: 14/263,726

(22) Filed: Apr. 28, 2014

(30) Foreign Application Priority Data
May 31, 2013 (JP) 2013-116344

(51) Int. Cl. G06F 21/60

(52) U.S. Cl. CPC G06F 21/60
USPC 726/26

(57) ABSTRACT

According to at least one embodiment, an electronic apparatus includes a wireless communicator, storage, and an erasing processor. The wireless communicator communicates with a management device connected to a network. The storage stores a plurality of account information elements and data. The plurality of account information elements correspond to a plurality of accounts. The plurality of account information elements include account names. The data correspond to the plurality of accounts. The erasing processor erases a first account information item corresponding to a first account in the plurality of accounts and first data corresponding to the first account when a request to erase the first account is received from the management device.

### CROSS-REFERENCE TO RELATED APPLICATIONS

This application is based upon and claims the benefit of priority from Japanese Patent Application No. 2013-116344, filed May 31, 2013, the entire contents of which are incorporated herein by reference.

### FIELD

Embodiments described herein relate generally to an electronic apparatus and a management method.

### BACKGROUND

Recently, the use of portable information terminals such as smartphones and tablet computers has surged, stimulating a demand to deploy such terminals in the workplace. Central to workplace deployment of these terminals is a method called Bring Your Own Device (hereinafter referred to as “BYOD”), where, instead of businesses providing their employees with terminals, the employees bring their own terminals and use them for work.

For businesses, BYOD brings such advantages as reducing costs and improving operational efficiency, but has the disadvantage of compromising security. Thus, a method for maintaining both security and convenience is necessary.

Several portable information terminals such as smartphones have a function (hereinafter referred to as “remote wipe”) allowing data in a terminal to be remotely erased should the terminal be lost or stolen. The remote wipe erases all elements of the data in the terminal. Accordingly, when the remote wipe is executed on an employee's terminal being used as part of a BYOD scheme, even the employee's private data, which essentially need not be erased, is erased. If the employee's private data is unnecessarily erased, recovery of the environment is troublesome when the terminal is returned to private use.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective illustration showing an example of an appearance of an electronic apparatus according to an embodiment.

FIG. 2 is a block view showing an example of a system configuration.

FIG. 3 is a perspective view showing an example of a system configuration of the electronic apparatus according to the embodiment.

FIG. 4 is a block diagram for explaining data corresponding to an account registered on the electronic apparatus according to the embodiment.

FIG. 5 is a flowchart showing an example of steps of erasing data corresponding to an office account in response to a request from a management server.

### DETAILED DESCRIPTION

Various embodiments will be described hereinafter with reference to the accompanying drawings.

In general, according to one embodiment, an electronic apparatus includes a wireless communicator, storage, and an erasing processor. The wireless communicator communicates with a management device connected to a network. The storage stores a plurality of account information elements and data. The plurality of account information elements correspond to a plurality of accounts. The plurality of account information elements comprise account names. The data correspond to the plurality of accounts. The erasing processor erases a first account information item corresponding to a first account in the plurality of accounts and first data corresponding to the first account when a request to erase the first account is received from the management device.

First, a structure of an electronic apparatus according to a present embodiment will be described with reference to FIG. 1. The electronic apparatus can be implemented as a portable terminal such as a tablet type personal computer, a laptop or notebook personal computer, and a PDA. Hereinafter, it is assumed that this path finding apparatus is implemented as a tablet type personal computer 10 (hereinafter referred to as a “computer 10”).

FIG. 1 is an illustration showing an appearance of the computer 10. The computer 10 is composed of a computer body 11 and a touchscreen display 17. The computer body 11 comprises a thin box-shaped housing. A power button 14 for powering on and off the computer 10 is provided on a surface of the computer body 11. The touchscreen display 17 is located on the surface of the computer body 11. The touchscreen display 17 comprises a flat panel display (such as a liquid crystal display [LCD]) and a touchpanel. The touchpanel is provided to cover the screen of the LCD. The touchpanel is configured to detect a position on the touchscreen display 17 which is touched by a user's finger or a pen.

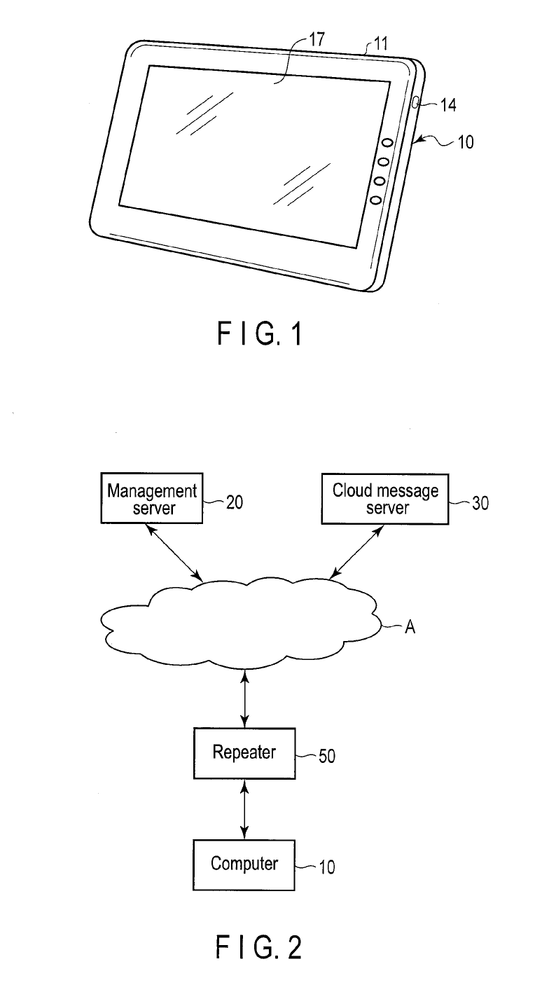

FIG. 2 is a block diagram showing a system configuration including the computer 10.

The system includes the computer 10, a management server 20, a cloud message server 30 etc.

The management server 20 pushes a message to the computer 10 via the cloud message server 30. A registration ID is allocated to the computer 10. The management server 20 sends the registration ID and the message to the cloud message server 30. The cloud message server 30 pushes the message to the computer 10 based on the registration ID.

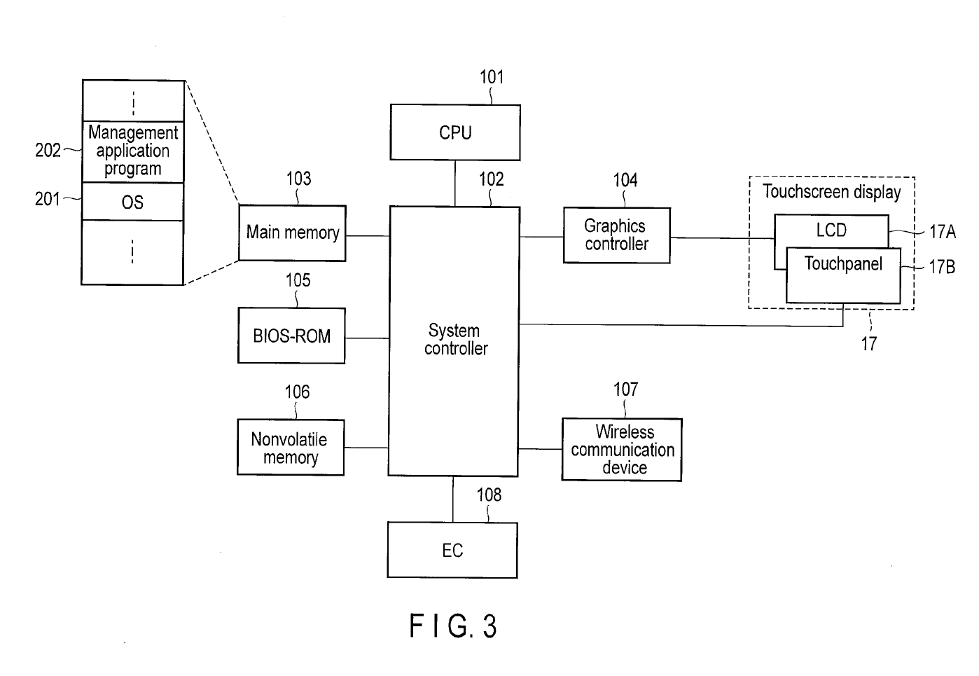

FIG. 3 is a block diagram showing a system configuration of the tablet computer 10.

As shown in FIG. 3, the tablet computer 10 comprises a CPU 101, a system controller 102, a main memory 103, a graphics controller 105, a BIOS-ROM 105, a nonvolatile memory 106, a wireless communication device 107, an embedded controller (EC) 108, etc.

The CPU 101 is a processor which controls an operation of each module in the tablet computer 10. The CPU 101 executes various types of software loaded from the nonvolatile memory 106, which is a. storage device, into the main memory 103. The software includes an operating system (OS) 201 and various types of application programs. The application programs include a management application program 202. The management application program 202 has a function to erase data corresponding to an account in response to a request from the management server 20.

The CPU 101 also executes a Basic Input/Output System (BIOS) stored in the BIOS-ROM 105. The BIOS is a program for hardware control.

The system controller 102 is a device which connects between a local bus of the CPU 101 and each component. A memory controller which executes access control of the main memory 103 is also built into the system controller 102. In addition, the system controller 102 has a function to communicate with the graphics controller 104 via, for example, a serial bus conforming to the PCI EXPRESS standard.

The graphics controller 104 is a display controller which controls an LCD 17A used as a display monitor of the tablet computer 10. A display signal generated by the graphics controller 104 is sent to the LCD 17A. The LCD 17A displays a screen image based on the display signal. A touchpanel 17B is located on the LCD 17A. The touchpanel 17B is a capacitive pointing device for inputting via a screen of the LCD 17A. A position on the screen touched by a finger, a movement of the touched position, etc., are detected by the touchpanel 17B.

The wireless device 107 is a device configured to execute wireless communication such as a wireless LAN and 3G mobile communication. The EC 108 is a one-chip microcomputer including the embedded controller for power management. The EC 108 has a function to power on and off the present tablet computer 10 in accordance with a user's operation of the power button.

A plurality of accounts can be registered on the computer 10. Each account includes account information and account data. The account information includes an account name, an account ID and a password. The account data includes an application and a data file. The account information and the account data corresponding to any of the accounts except an account (hereinafter referred to as the “owner account”) registered first on the computer 10 can be erased.

The above-mentioned account erase program is installed under an account corresponding to the owner account. The account erase program has system authority and is active if the user logs in using an account other than the owner account.

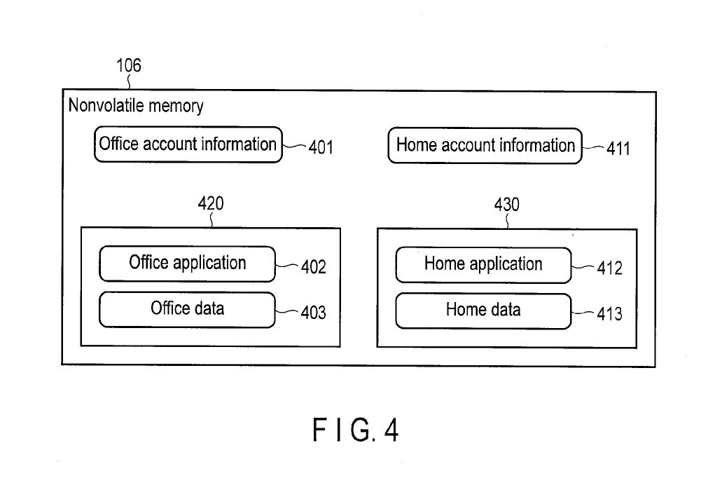

FIG. 4 is a block diagram for explaining data corresponding to an account registered on the electronic apparatus according to the embodiment.

A home account and an office account are registered on the computer 10. The home account is an account privately used by the user and is an owner account. The office account is an account used by the user for work.

The nonvolatile memory 106 of the computer 10 stores home account information 401, a home application 402 and home data 403 corresponding to the home account. The computer 10 stores office account information 411, an office application 412 and office data 413 corresponding to the office account. The home application 402 and the home data 403 are stored in a home folder 420 corresponding to the home account. The office application 412 and the office data 413 are stored in an office folder 430 corresponding to the office account.

The above-mentioned management application program 202 requests the operating system 201 to erase the office account information 411, the office application 412 and the office data 413 corresponding to the office account in response to the request from the management server. The management application 202 instructs the operating system 201 to erase the account by using the account ID as an argument. The operating system 201 erases the office application 412 and the office data 413 by erasing the office folder 430.

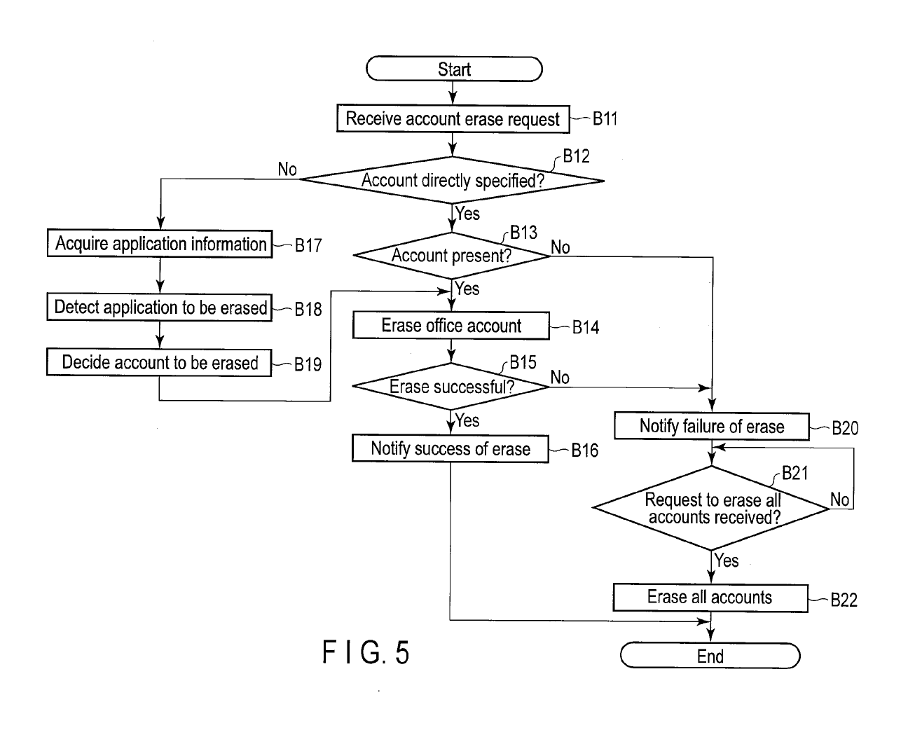

Steps of erasing the data corresponding to the office account in response to the request from the management server will be described with reference to a flowchart of FIG. 5.

The management server 20 requests the cloud message server 30 to send a message which requests an access to the management server 20 to the computer 10. The cloud message server 30 sends the message which requests the access to the management server 20 to the computer 10. The management application program 202 accesses the management server 20. The management server 20 sends to the management application program 202 an account erase request for requesting that the office account or the account corresponding to the application used for work be erased.

A security administrator or a terminal holder can directly specify the account for business to be erased with respect to the management application via the management server 20. Information for specifying the account depends on the OS. If the OS is, for example, Android (registered trademark), the information may be a character string of the account name and the account ID.

The computer 10 receives the account erase request (step B11). The management application program 202 determines whether the account erase request directly specifies an account (step B12).

If the account is determined to be directly specified (Yes in step B12), the management application program 202 determines whether the specified office account exists (step B13). If the account is determined to be present (Yes of B13), the management application program requests the operating system 201 to erase the office account information, the office application and the office data corresponding to the office account (step B14). The operating system 201 erases the office account information, the office application and the office data corresponding to the office account, in response to the request. The management application program 202 determines whether the erase is successful (step B15). If the erase is determined to be successful (Yes in step B15), the management application program 202 requests the management server 20 to succeed in erasing.

If the specified account is not determined to be present in step B13 (No in step B13) or the erase is determined to be unsuccessful (No in step B15), the management application program 202 notifies the management server 20 that the erase has failed (step B20). The management application program 202 determines whether the request to erase all the accounts from the management server 20 is received (step B21). If the erase request is determined to be received (Yes in step B21), the management application program 202 requests the operating system 201 to erase the account information, the application and the data corresponding to at least one account other than the home account (step B22). The operating system 201 erases the account information, the application and the data corresponding to the at least one account other than the home account.

If the account is not determined to be directly specified in step B12 (No in step B12), the management application program 202 acquires application information indicating information on the application installed under each account registered on the computer 10 (step B17). In the application information, the installed application is associated with the account. The management application program 202 detects the application to be erased based on the application information (step B18). The management application program 202 decides the account to be erased which is associated with the detected application to be erased (step B19). The management application program 202 requests the operating system 201 to erase the account information, the application and the data corresponding to the decided account (step B14). The operating system 201 erases the account information, the application and the data corresponding to the requested account. The management application program 202 executes processing following step B15.

If the terminal is stolen or lost, the data can be satisfactorily erased by erasing the data corresponding to the office account and maintaining the data corresponding to the home account in response to the erase request from the management server 20. Consequently, no effort is involved in recovering the environment when the terminal is returned to private use.

By supplying the means to erase only the particular account, both employee convenience and company security can be achieved. Since the user's private data is not erased, the advantage of reducing employee resistance to BYOD can be expected. Since only the particular account is erased, time for the process is shorter than time for erasing all elements of the data. Accordingly, it is unlikely that the data fails to be erased because of, for example, a flat battery.

It should be noted that, in some business-oriented applications, there is a possibility that the data is stored in areas not separated by accounts. These areas can be erased by notifying the management application of file information to be additionally erased when the management server notifies the erase request.

All the steps of the account erase process according to the present embodiment can be executed by software. Thus, the same advantage as the present embodiment can be easily achieved by installing the computer program on a general computer via a computer-readable storage medium, which stores the computer program for executing the steps of the account erase process, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a wireless communicator configured to communicate with a management device connected to a network;
storage configured to store a plurality of account information elements and data, the plurality of account information elements corresponding to a plurality of accounts, the plurality of account information elements comprising account names, and the data corresponding to the plurality of accounts; and
an erasing processor configured to erase a first account information item corresponding to a first account in the plurality of accounts and first data corresponding to the first account when a request to erase the first account is received from the management device.

2. The apparatus of claim 1, wherein the erasing processor is configured to not erase second account information item corresponding to a second account in the plurality of accounts that is different from the first account or second data corresponding to the second account when the request to erase the first account is received from the management device.

3. The apparatus of claim 1, further comprising a notifier configured to notify the management device that erasing of the first account information item and the first data has failed when the erasing processor fails to erase the first account information item and the first data.

4. The apparatus of claim 1, further comprising a detector configured to, when a request to erase an account corresponding to a first application program is received, detect a second account corresponding to the first application program from the storage,
wherein the erasing processor is configured to erase second account information item corresponding to the second account and second data corresponding to the second account from the storage.

5. The apparatus of claim 4, further comprising a notifier configured to notify the management device that the erase has failed, when the erasing module fails to erase the second account information item and the second data.

6. The apparatus of claim 1, wherein the erasing module is configured to erase one or more fourth account information items corresponding to one or more fourth accounts obtained by excluding a third account from the plurality of accounts, and fourth data corresponding to each of the fourth accounts, when a request to erase the plurality of accounts is received from the management device.

7. A method of managing an electronic apparatus comprising storage configured to store a plurality of account information elements and data, the plurality of account information elements corresponding to a plurality of accounts, the plurality of account information elements comprising account names, and the data corresponding to the plurality of accounts, the method comprising:
erasing a first account information item corresponding to a first account in the plurality of accounts and first data corresponding to the first account when a request to erase the first account is received from a management device connected to a network.

8. A computer-readable, non-transitory storage medium comprising a computer program configured to be executed by a computer comprising storage configured to store a plurality of account information elements and data, the plurality of account information elements corresponding to a plurality of accounts, the plurality of account information elements comprising account names, and the data corresponding to the plurality of accounts, the computer program configured to cause the computer to execute a function of:
erasing a first account information item corresponding to a first account in the plurality of accounts and first data corresponding to the first account when a request to erase the first account is received from a management device connected to a network.
